(19) United States
(12) Patent Application Publication
(10) Pub. No.: US 2018/0309349 A1
(43) Pub. Date: Oct. 25, 2018

(54) Adaptive Polyphase Motor

(71) Applicant: Axel Michael Sigmar, Lago Vista, TX (US)

(72) Inventor: Axel Michael Sigmar, Lago Vista, TX (US)

(21) Appl. No.: 15/859,507

(22) Filed: Dec. 30, 2017

Related U.S. Application Data
(60) Provisional application No. 62/440,984, filed on Dec. 30, 2016.

(51) Int. Cl. H02K 11/33; H02K 16/02

(52) U.S. Cl. CPC H02K 11/33; H02K 2213/12; H02K 16/02

(57) ABSTRACT

In some embodiments, an electric motor may include a plurality of magnetic circuit modules, where each magnetic circuit module includes a rotor having a first magnetic array and a second magnetic array extending substantially parallel with one another and spaced apart by a channel. The electric motor may further include a stator including a coil assembly configured to fit within the channel and to provide an electromagnetic force within the channel to accelerate the magnetic arrays.

### CROSS-REFERENCE TO RELATED APPLICATION(S)

This application is a non-provisional of and claims priority to U.S. Provisional Patent Application No. 62/440,984 filed on Dec. 30, 2016 and entitled “Active Series Hybrid Integrated Electric Vehicle”, which is incorporated herein by reference in its entirety.

### FIELD

The present disclosure is generally related to electric motors, and more particularly to an adaptive polyphase electric motor.

### BACKGROUND

An electric motor is an electromechanical machine that can be used to supply motive power for a vehicle or some other device with moving parts. Further, an electric motor can be utilized to convert kinetic energy of a mechanical system into electric potential energy. In some incarnations, both transforms of energy may be utilized. Most electric motors operate via interactions between multiple magnetic circuits whereby magnets, permanent and electromagnet, are arranged specifically to pass through corresponding magnetic circuits at given time intervals. The electromagnets in this arrangement by virtue may utilize electric potential to generate force, or utilize external force to generate electric potential.

In some examples, electric motors can be used in a variety of devices, including but not limited to, fans, blowers, pumps, machine tools, household appliances, power tools, electric vehicles, other devices, or any combination thereof. Motors can be powered by direct current (DC) power sources, which may include batteries, or by alternating current (AC) sources, such as from the power grid, inverters, generators, or mechanical sources such as internal combustion engines, hydraulic turbines, steam turbines, or any combination thereof.

### SUMMARY

In some embodiments, an electric motor may include a plurality of magnetic circuits, where each magnetic circuit contains an arrangement of magnetic circuit modules; typically configured as a rotor having a first magnetic array and a second magnetic array extending substantially parallel with one another and spaced apart by a channel. The electric motor may further include a stator including a plurality of electromagnet coil assemblies configured to fit within the channel and to provide an electromotive force within the channel to accelerate the magnetic arrays. In some embodiments, the stator may include a plurality of individual electromagnetic coil assemblies, each of which may have individual electromagnetic drive circuity and individual cooling jackets.

In some embodiments, the first magnetic array may include a circular array forming a closed magnetic loop. The second magnetic array may include a circular array forming a second closed magnetic loop that fits within the first magnetic array. The coil assembly may include a plurality of electromagnets configured to fit within a channel between the first and second magnetic arrays.

### BRIEF DESCRIPTION OF THE DRAWINGS

FIG. 1 depicts a block diagram of a system including a control system coupled to a motor, in accordance with certain embodiments of the present disclosure.

FIG. 2 depicts an exploded view of the electric motor of FIG. 1, in accordance with certain embodiments of the present disclosure.

FIG. 3 depicts a view of a portion of the motor of FIG. 2 including a magnetic circuit array having the rotor with inner and outer magnetic arrays and including a plurality of coils of the stator assembly, in accordance with certain embodiments of the present disclosure.

FIG. 4 depicts a view of magnetic fields produced by the portion of the motor of FIG. 3 showing that the magnetic field lines are contained by the inner and outer magnetic arrays, in accordance with certain embodiments of the present disclosure.

FIG. 5 depicts a perspective view of the stator of the motor of FIGS. 1-4, in accordance with certain embodiments of the present disclosure.

FIG. 6 depicts a top view of the stator of FIG. 5, in accordance with certain embodiments of the present disclosure.

FIG. 7 depicts a top view of a portion of the motor of FIGS. 1-6 depicting field lines extending between inner and outer magnet arrays through stator coils positioned between the arrays, in accordance with certain embodiments of the present disclosure.

FIG. 8 depicts a top view of a portion of the motor of FIGS. 1-7 depicting magnetic field lines and curvature of the arrays and the stator, in accordance with certain embodiments of the present disclosure.

FIG. 9 depicts a portion of the motor of FIGS. 1-8 including portions of the inner and outer magnetic arrays and the stator, in accordance with certain embodiments of the present disclosure.

FIG. 10A depicts a portion of the motor of FIGS. 1-8 rearranged as an array, in accordance with certain embodiments of the present disclosure.

FIG. 10B depicts a cross-sectional view of the array taken along line B-B in FIG. 10A.

FIG. 10C depicts a cross-sectional view of a magnetic coil assembly taken along line C-C in FIG. 10B.

FIG. 11 depicts a system including a circuit configured to drive a magnetic coil assembly of the motor of FIGS. 1-10C, in accordance with certain embodiments of the present disclosure.

FIG. 12 depicts a system including an electric powered vehicle, which may include one or more electrical motors, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

In the following detailed description of embodiments, reference is made to the accompanying drawings which form a part hereof, and which are shown by way of illustrations. It is to be understood that features of various described embodiments may be combined, other embodiments may be utilized, and structural changes may be made without departing from the scope of the present disclosure. It is also to be understood that features of the various embodiments and examples herein can be combined, exchanged, or removed without departing from the scope of the present disclosure.

In accordance with various embodiments, some of the methods and functions described herein may be implemented as one or more software programs running on a computer processor or controller, which may be configured to interact with various devices, for example to control their operations. In certain embodiments, such a processor or controller may be a component of a computing device, such as a tablet computer, a smartphone, a personal computer, a server, a dedicated integrated computing device, or any combination thereof. Dedicated hardware implementations including, but not limited to, application specific integrated circuits, programmable logic arrays, and other hardware devices can likewise be constructed to implement the methods and functions described herein. A layered hierarchical architecture of computational, control and communication devices may be included proximate to the assemblies that they sense and control, both individually and in combination, to achieve the combinatorial behavior desired on varying dynamic timeframes. Further, at least some of the methods described herein may be implemented as a device, such as a computer readable storage device or memory device, including instructions that when executed cause a processor to perform the methods.

Embodiments of systems and apparatuses are described below that include a motor having a rotor and a stator assembly configured to provide motive force in response to electrical currents supplied to the electromagnetic coils (electromagnets) of the stator assembly. The motor represents a direct drive, high torque, efficient, high power density, lightweight electrical machine design that can be implemented in a variety of contexts to drive a plurality of applications. The motor represents a new class of motor (and generator or alternator) based on a confluence of geometries, materials, manufacturing processes, power electronics, and control thereof.

The motor may include an array of independent magnetic circuits, which can be controlled independently to provide an adaptive polyphase motor. Each coil of the stator assembly may be physically close to its own drive electronics, which enhances fast switching and low-loss energy recovery and reuse. In general, efficient fast switching improves (or even maximizes) the useful energy or work done within the electrical cycle of each coil as the magnet passes by, transferring energy between the dual airgaps (provided between the stator coil and the permanent magnets of an inner magnetic array and an outer magnetic array). In some embodiments, the drive electronics may include inductors and capacitors directly associated with each coil (as part of or in addition to a snubber circuit), which can reduce (or even minimize) the inherent (or parasitic) losses and acoustic noise, which generate heat and subtract from the overall efficiency of the motor. This can be a significant improvement over conventional compromises made in three, six, or other such variants of conventionally phased motors.

Embodiments of a motor are described below that include a stator including a plurality of coils and a rotor including an inner magnetic array and an outer magnetic array, which arrays are formed from plurality of permanent magnets. The permanent magnets may be formed from a plurality of segmented magnets of the same size, composition, and magnetic properties, which magnets may be arranged and coated to provide a desired magnetic field arrangement with little or no magnetic field line leakage.

In general, the concentrated magnetic field provides significant advantages. First, significant torque (circumferential magnetic motive force) increase is achieved and overall weight reduction can be attained. The coils may be formed from a stator hoop-on-plate configuration. The rotors include dual magnetic arrays (also hoop-on-plate) formed from segmented magnetic arrays of permanent magnets, which complete a magnetic circuit on both sides of each stator coil without back iron, reducing weight (rotational inertia), reducing eddy current losses, and significantly reducing or eliminating field line leakage external to the working volume. The reduced weight enhances the balance of the motor and substantially reduces large radial forces usually exerted on the stator hoop. Further, the design and arrangement of the segmented magnetic array on both sides of the stator coils operates to confine the magnetic field, obviating the currents induced by stray magnetic fields, which could otherwise operate to heat and weaken structural materials. Further, the confinement of the fields enables the use of non-ferromagnetic materials as structural components, which allows for selection of lighter composite materials, reducing weight, reducing heat retention and further removing the bearing current problems that plague conventional electric machines.

The switching circuitry and the coils may be cooled by the localized integration of thermally conductive insulators which are not affected by eddy current losses. Further the magnetic arrays may be thermally balanced with pyrolytic graphite (isotopically thermally very conductive material that is compatible with carbon fiber composite structures). Further, the motor components can be further shielded by magnetically and thermally conductive mu-metals shields. An Mu-metal is a nickel—iron soft ferromagnetic alloy with very high permeability, which can be used for shielding sensitive electronic equipment against static or low-frequency magnetic fields. The mu-metal shields can be electrically grounded (special bearing considerations), which, in conjunction with similar precautions in the stator plate, electronics housings, and conductor shielding can result in virtually no detectable magnetic signature. This is desirable in submarines and advanced minesweeping vessels and vehicles.

In certain embodiments, the magnetic arrays contain almost all of the magnetic field from the permanent and electromagnets. Further, power density (in kW/kg and KW/liter terms) is enhanced because sources of losses are minimized, remaining loss heat is actively removed, and lightweight materials are able to be utilized due to the advantageous compact geometry and manufacturable modular design of these electrical machines.

In some embodiments, a control system may interact with drive electronics circuitry for each coil to control and monitor each coil independently. In some embodiments, the control system may selectively activate some, but not all, of the coils to allow for segmented, individual actuation. In some embodiments, the addition of a number of sets or “pole pairs” of inner and outer magnetic sources can be added to abate the magnetic alignment or “magnetic locking” of a rotating assembly or rotor. Further configurations may be utilized to match the modal requirements of the accompanied loads in the effected system. The control system may control the electromagnets asynchronously as desired to drive the rotation. Further, the electromagnets may be controlled using a plurality of different phases of a periodic signal, such as a square wave or a sinusoidal signal.

In some embodiments, the electromagnets may be driven by a selected number of phases, where the number of phases may be selectively controlled and dynamically changed or augmented to achieve a desired motive force. A control circuit or system may be configured to control the signals to drive the electromagnets via the drive electronics of each coil. Further, the control circuit may selectively activate some, but not all, of the electromagnets at selected pulses. For example, to reduce power consumption, once the rotor is moving at a selected speed, the control circuit may selectively disable some of the electromagnets and selectively drive other electromagnets to maintain the selected speed, while reducing overall power consumption. Other embodiments are also possible.

In some embodiments, the motor may include a plurality of magnetic circuit modules, each of which may include an inner magnetic source, a central magnetic source, and an outer magnetic source. The central magnetic source may be coupled to a stator, which is configured to drive a rotor that includes the inner and outer magnetic sources. The magnetic sources may be permanent, electromagnetic, or any combination thereof. The magnetic sources may be arranged in a variety of arrays. In some embodiments, the magnetic poles of the inner magnetic sources may be offset by one-half of a pole pitch relative to the outer magnetic sources. In some embodiments, the magnetic pole alignment of the central magnetic source may be as close to parallel to a center line between the inner magnetic source and the outer magnetic source. When the inner and outer magnetic sources are arranged in circular arrays, the pole alignment can be parallel to a tangent line of the circular arrays at a center point of the central magnetic source.

In some embodiments, a motor may include a rotor having an inner circumferential array of magnets and an outer circumferential array of magnets separated by an air gap defining a channel. The motor may further include a stator assembly including a plurality of magnetic sources configured to fit within the channel. In some embodiments, the rotor is configured to rotate relative to the stator in response to magnetic fields presented by the magnetic sources of the stator assembly. Other embodiments are also possible.

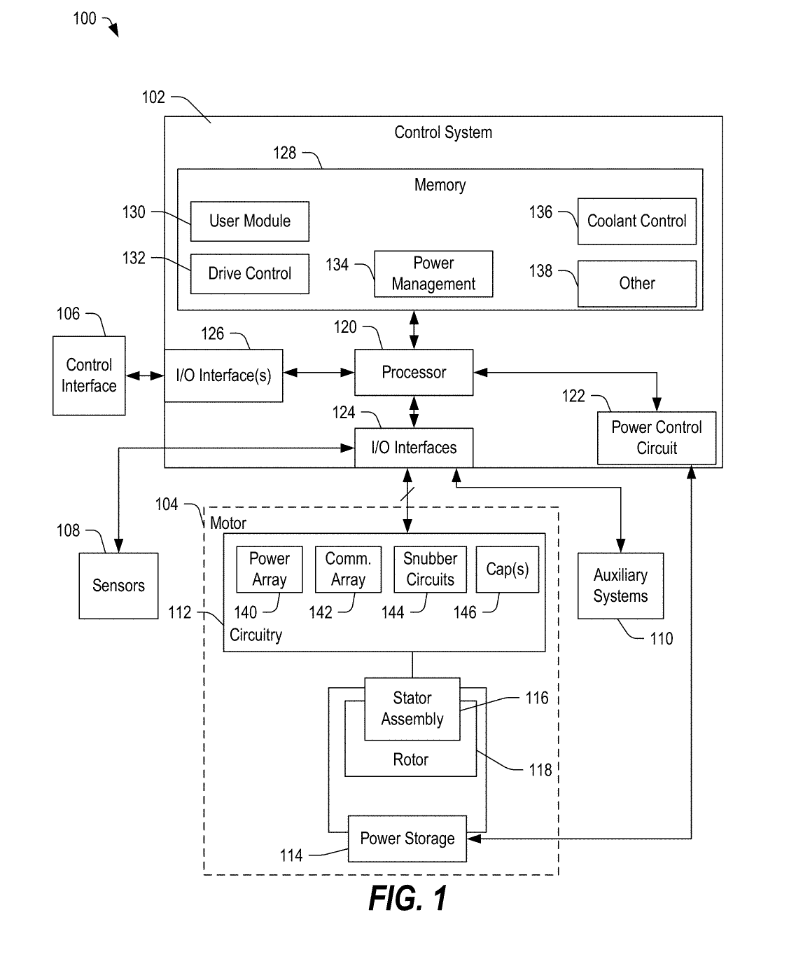

In some embodiments, the magnetic sources of the stator assembly may be electromagnetic and may be controlled by a control circuit to drive the rotor. The magnetic coils of the stator may consume power according to the resistance as well as the inductance provided by the magnetic coil. The control circuit may drive the stator using direct current (DC) power, but the time-varying nature of the current leaving the coil implicates fringing and skin depth related issues with respect to the surface area of the conductor. By utilizing an insulated gate bipolar transistor (IGBT) or other insulated circuit for switching, the current from the coil may be selectively directed onto a power bus, which can have a large surface area. The circuitry may be mounted to the stator and immersed in oil, such as a silicone-based oil, for cooling. Further, in some embodiments, the stator coils may be turned horizontally and the core of the coils may be driven into partial magnetic saturation to enhance the motive force applied to the rotor. One possible implementation of a system including such a motor is described below with respect to FIG. 1.

FIG. 1 depicts a block diagram of a system 100 including a control system 102 coupled to a motor 104, in accordance with certain embodiments of the present disclosure. The control system 102 may be coupled to a control interface 106, one or more sensors 108, one or more auxiliary systems 110, and a power control circuit 112. The system 100 may further include power storage 114, such as a plurality of capacitors or rechargeable batteries, which may be coupled to the control system 102.

In some embodiments, the motor 104 may include a stator assembly 116 arranged relative to a rotor 118, which may be configured to rotate relative to the stator assembly 116. The stator assembly 116 may be bolted or otherwise attached to a housing of the motor 104, so that the motive force created by the stator coils may cause the rotor 118 to rotate about an axis. In some embodiments, the control system 102 may be configured to control each stator coil independently to provide independently controllable magnetic circuit modules in conjunction with the inner and outer permanent magnet arrays of the rotor 118.

The control system 102 may include a processor 120 coupled to a power control system 122, which may be coupled to the power storage 114 to control delivery of power to the motor 104 and to the control system 102. The control system 102 may further include one or more input/output (I/O) interfaces 124 coupled to the processor and configured to couple to the stator assembly 116 of the motor 104. In some embodiments, the processor 120 may control switches and other circuitry within the motor 104 to control operation of the motor 104 by sending control signals through the one or more I/O interfaces 124.

The control system 102 may further include I/O interfaces 126 coupled to the processor 120 and configured to couple to the control interface 106 to receive input, such as from a user. The control system 102 may further include a memory 128 coupled to the processor 120. The memory 128 may be configured to store data and to store instructions that may, when executed, cause the processor 120 to perform a variety of operations. It should be understood that the memory 128 may include volatile memory, such as cache memory, and non-volatile memory, such as flash memory, hard disc devices, or any combination thereof.

In the illustrated example, the memory 128 may include a user module 130 that, when executed, may cause the processor 120 to receive data from the control interface 106. In an example, the control interface 106 can include a steering input, an acceleration input, a braking input, or other input. In another example, the control interface 106 can include a pressure input (such as for maintenance of a fluid pressure in a drilling context) or another input mechanism that can provide data for use by the control system 102 for controlling operation of the motor 104. Other embodiments are also possible.

The memory 128 may further include drive control instructions 132 that, when executed, may cause the processor 120 to generate control signals automatically or in response to signals from the control interface 106 and to provide the control signals to the motor 104 through the I/O interfaces 124. In some embodiments, the control signals may cause the stator assembly to selectively activate the coils. In a particular example, the control signals may include periodic signals, such as square wave or sinusoidal signals, which may be selectively applied to one or more of the coils, independently. In some embodiments, the drive control instructions may cause the processor 120 to drive the coils asynchronously and with any number of phases. Other embodiments are also possible.

The memory 128 may also include a power management module 134 that, when executed, may cause the processor 120 to generate control signals to control the delivery of DC power from the power storage 114 by sending the control signals to the power control circuit 122, which then controls the power storage 114. The memory 128 may also include a coolant control module 136 that, when executed, may cause the processor 120 to generate coolant control signals and to provide the coolant control signals to the motor 104 to control a coolant pump or other element of the motor 104 to provide cooling for the stator assembly 116.

The memory 128 may further include other instructions 138 that, when executed, may cause the processor 120 to perform other operations, such as providing feedback to the control interface 106. Other embodiments are also possible.

The motor 104 may include circuitry 112 coupled to the control system 102 through the I/O interfaces 124. The circuitry 112 can include a power array 140 configured to deliver power from the control system 102 (or from a power storage device controlled by or associated with an overall system) to other circuits and to the stator assembly 116. The circuitry 112 can further include a communications array circuit 142 configured to facilitate communication of sensor data (from sensors 108, for example) and control signals between the motor 114 and the control system 102.

The circuitry 112 may further include capacitors 146 and snubber circuits 144. It should be appreciated that each coil of the stator assembly 116 may include a snubber circuit 144 and capacitors 146 to suppress current and voltage spikes from switching the current through the coils of the stator assembly and to reuse at least some of the voltage to recharge the coil or to reverse current flow through the coil during switching. In some examples, the capacitors 146 may be part of the snubber circuits 144.

In some embodiments, the system 100 may be configured to provide motive force by applying control signals to the stator assembly 116 through the communications array 142 to drive the movement of the rotor 118. The geometry of the rotor assembly 118, including the dual magnetic arrays 210 and 212, provides a minimum of a doubling in torque over a conventionally arranged rotor/stator configuration for the same number of turns. In some embodiments, the system 100 may receive signals from the one or more sensors 108 and may selectively control operation of the motor 104, at least in part, based on the signals from the sensors 108. In some embodiments, the sensors 108 may include temperature sensors, rotational speed sensors, pressure sensors, other sensors, or any combination thereof. In some embodiments, the sensors 108 may be included within the motor 104.

In some embodiments, the circuitry 112 may be duplicated for each coil of the plurality of coils of the stator assembly 116, allowing for independent control and independent energy storage for each coil. This allows for unprecedented machine flexibility in terms of adjustable resolution on a per coil basis to increase the efficiency of each of the coils and for each node.

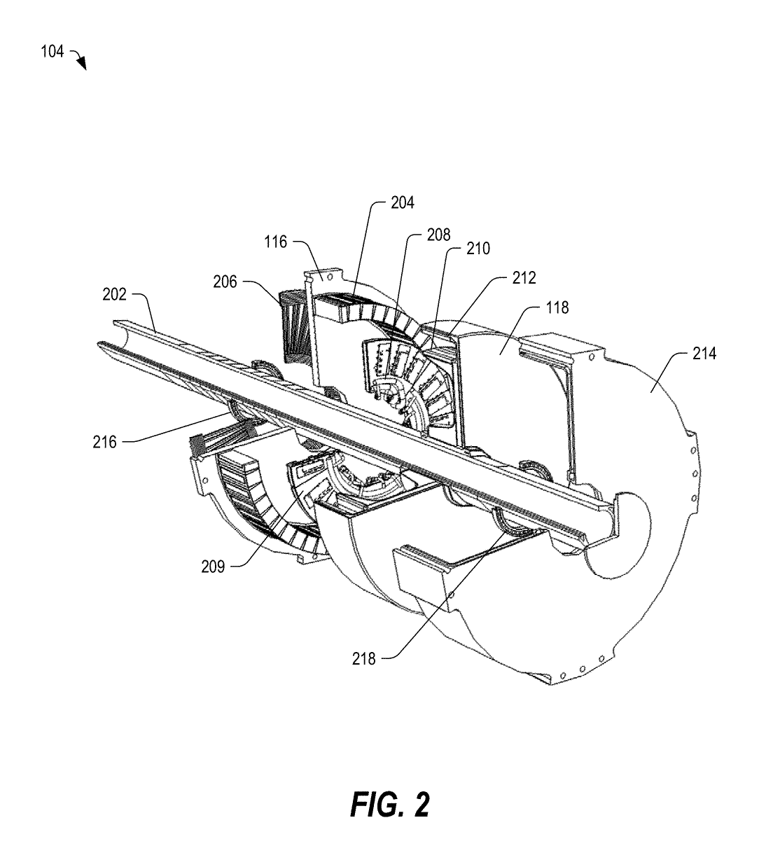

FIG. 2 depicts an exploded view of the electric motor 104 of FIG. 1, in accordance with certain embodiments of the present disclosure. The motor 104 may include a stator assembly 116 and a rotor 118. The motor 104 may include a crank shaft 202, which may extend through an opening of the stator assembly 116 and which may be coupled to the rotor 118 so that the rotational movement of the rotor 118 may turn the crank shaft 202. In some embodiments, at least a portion of the stator assembly 116, the rotor assembly 118, and a housing cover 214 may be formed from carbon fiber or other composite materials.

The stator assembly 116 may be bolted to a frame or housing of a structure, such as a frame of a vehicle, a housing of a pump, or some other structure, so that the electromagnetic force can cause the rotor 118 to turn relative to the stator assembly 116 and the structure. The stator assembly 116 may include a plurality of coil assemblies 204, each of which may include a wire coil wrapped around a laminate core. The stator assembly 116 may be coupled to control circuitry and to one or more power sources (such as batteries) through a radial circumferential power array 206, which may be electrically coupled to the coil assemblies 204 and to an insulated gate bipolar transistor (IGBT) circuit 209, which may include a cooling assembly 208 as well as a snubber circuit and capacitors for temporary storage of voltages during current switching operations in order to recover and reuse power from the coils 204 and without having to deliver the power to an external circuit, which could introduce losses. The IGBT circuit 209 may be an embodiment of the circuitry 112 in FIG. 1.

In some embodiments, the cooling assembly 208 can include a cooling arch and power distribution cooling plates configured to cool the coils 204 and associated circuitry 209, which may heat in response to current flow through the coils and switching the current flow on and off. The IGBT circuit 209 may be configured to operate an electrical switch to provide high efficiency and fast switching between the ends of the coils 204 and the snubber circuit and capacitors.

The motor 104 may further include the rotor 116, which includes an inner magnetic array 210 and an outer magnetic array 212 spaced apart by an air gap that defines a channel sized to receive the electromagnetic coils 204 of the stator 116. The magnets of the magnet arrays 210 and 212 may be configured in an array where the magnets are arranged to provide a spatially rotating pattern of magnetization. The permanent magnets of the arrays 210 and 212 can provide a magnetic flux distribution that interacts with the magnetic fields produced by current flowing through the coils 204 of the stator assembly 116. The interaction between the magnetic flux distribution and the induced magnetic fields may accelerate the rotor 118 rotationally about an axis corresponding to the axis of the crank shaft 202.

The motor 104 may further include a housing cover 214, which may couple to a substrate of a stator assembly 116 to form a sealed enclosure. In some embodiments, the stator assembly 116, the coils 204, the IGBT circuit 209 (including capacitors and snubber circuits), and the cooling assembly 208 may be sealed within the enclosure, which may be filled with an oil to facilitate cooling of the circuitry. In some embodiments, the oil may be circulated using a pump or other controllable device to facilitate cooling of the components. Further, in the illustrated example, bearings 216 and 218 are depicted. Other components may also be included, which are omitted here for ease of discussion.

In some embodiments, the magnetic arrays may be formed by a plurality of small magnets, which may be coated to facilitate magnetic field containment and which may be interconnected and arranged to direct magnetic field lines to remain within the periphery of the arrays 210 and 212. By containing the magnetic fields with the working volume, external structures for further containment of the magnetic fields may be omitted. In some embodiments, the housing cover 214, for example, may be formed from plastic, Teflon, a different composite material, or any combination thereof. The ability to use other materials allows the motor to be formed from a relatively light structural material, reducing weight loads and making it easier to turn the rotor 118. Moreover, the lighter material can reduce heat retention and provide for a more efficient motor design. Other embodiments are also possible.

The motor 104 is implemented as a direct drive, high torque, efficient, high power density, lightweight electric machine design that can be designed to enable many applications, including motors, actuators, pumps, generators, other systems, or any combination thereof. A new class of motor and generator or alternator is also possible from the confluence of geometries, materials, manufacturing processes, power electronics and control thereof, which are described herein.

Each coil of the stator 116 of this adaptive, polyphase motor 104 is close to its own drive electronics or circuitry 209. Efficient fast switching of the current into and out from the coils 204 maximizes the useful energy or work done in the electrical cycle of each coil 204 as the magnet passes by, transferring energy between the dual airgaps (between the coil 204 and the inner magnet array 210 and the outer magnet array 212). The circuitry 209 includes inductors and capacitors (as part of or in addition to a snubber circuit) directly associated with each coil 204. During switching, power from the coil 204 may be stored in a capacitor (and/or snubber circuit) close to the coil 204, reducing the inherent (parasitic) losses and acoustic noise, which generate heat and subtract from the overall efficiency of the motor 104. This reduction in losses and heating can provide a significant improvement in motor architectures, particular as the number of phases of the motor increases.

The motor 104 provides significant torque (circumferential magnetic motive force) increases and weight reduction. In particular, the stator assembly 116 is a hoop-on-plate configuration, which interfaces with dual rotors 118 (also hoop-on-plate) comprised of segmented magnetic arrays (such as Halbach arrays) of permanent magnets. The magnetic arrays 210 and 212 cooperate to complete the magnetic circuit on both sides of the stator coil 204 without back iron, reducing weight (rotational inertia) and eddy current losses. The omission of back iron allows for lighter materials and improved balance of the system, substantially reducing the large radial forces usually exerted on the stator hoop assembly 116.

The segmented magnetic arrays confine the magnetic field, obviating the currents induced by stray magnetic fields, which otherwise heat and weaken structural materials and reduce overall efficiency. The magnetic arrays contain almost all of the magnetic field from the permanent and electromagnets. The motor can be further shielded as necessary by magnetically and thermally conductive mu-metal shields. The mu-metal may include a nickel-iron soft ferromagnetic alloy with very high permeability, which can used for shielding sensitive electronic equipment against static or low-frequency magnetic fields. The mu shields may be electrically grounded. The stator plate, electronics housings and conductor shielding can result in virtually no detectable magnetic signature, which may be desirable in magnetically sensitive applications, such as in submarines and advanced minesweeping vessels and vehicles.

The cooling circuitry 208 can include an integrated pyrolytic graphite (isotropically thermally very conductive material that is compatible with carbon fiber composite structures). Other cooling techniques may also be used, including thermal oil cooling and other cooling techniques.

The motor 104 enhances the overall power density (in kW/kg and KW/liter terms) because all sources of losses are minimized, remaining loss heat is actively removed, and lightweight materials are able to be utilized due to the advantageous compact geometry and manufacturable modular design of the motor. Further, load paths from the stator assembly 116 to the stator plate to the outer motor housing 214 and onward to the load are short, direct and take full advantage of large diameters and high material modulus, resulting in a compact, stiff, quiet machine that is easily coupled to the load.

Machine health management (superior to monitoring) is enabled by monitoring temperatures and electrical characteristics along with baselines in each coil and power electronics unit at each coil individually. Further, performance (torque at desired Revolutions per Minute (RPM)) can be maximized within limits of machine health management on a continuous or burst mode basis, within each coil and power electronics unit. Normally efficiency can be maximized to minimize losses and heat generated at the desired power. Further, each coil 204 can be controlled independently to provide a desired performance and efficiency.

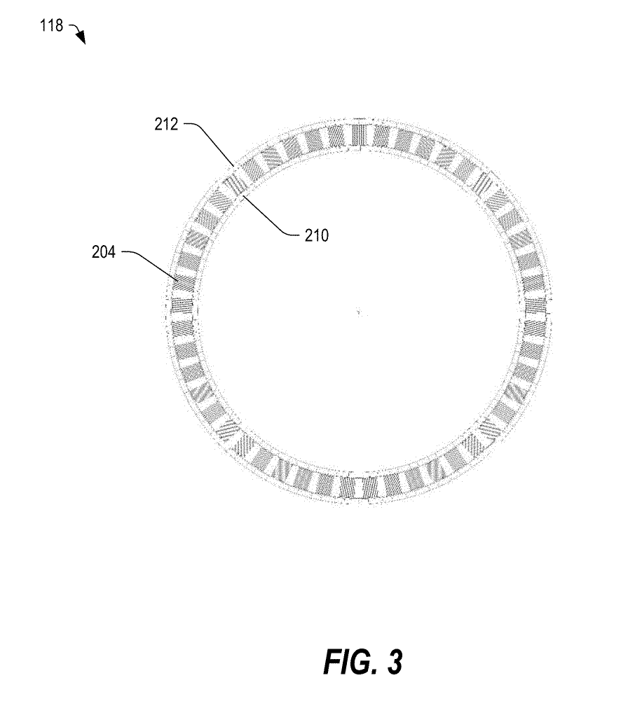

FIG. 3 depicts a view of a portion of the motor of FIGS. 1-2 including a magnetic circuit array 300 that includes the rotor 118 with inner and outer magnetic arrays 210 and 212 and that includes a portion of the stator assembly 116, in accordance with certain embodiments of the present disclosure. In the illustrated example, a magnetic circuit array 300 may include an inner magnetic source including the inner magnetic array 210. The magnetic circuit array 300 may further include an outer magnetic source including the outer magnetic array 212. The magnetic circuit array 300 may also include a plurality of coils 204 of the coil assembly 116. Each coil may include an electrically conductive wire wound around a laminate core.

In some embodiments, the laminate core may extend substantially parallel to the inner and outer magnetic arrays 210 and 212. The wire coils that form the coil assemblies 204 may be wrapped around the laminate core such that the north/south poles of the coil assemblies 204 extend substantially parallel to the tangents of the inner and outer magnetic arrays 210 and 212 through the core.

In the illustrated example, the permanent magnets that form the inner array 210 and the outer array 212 may be formed from a plurality of magnets, each of which may have approximately the same size, the same material composition, and the same magnetic parameters. In some embodiments, the plurality of magnets can be small rectangular or cylindrical magnets. By utilizing the same size magnets small magnets for all of the array magnets, the costs may be reduced because the component magnets can be purchased in bulk, thereby reducing supply costs. Moreover, the smaller magnets can be coupled to one another and arranged to provide the desired magnetic fields.

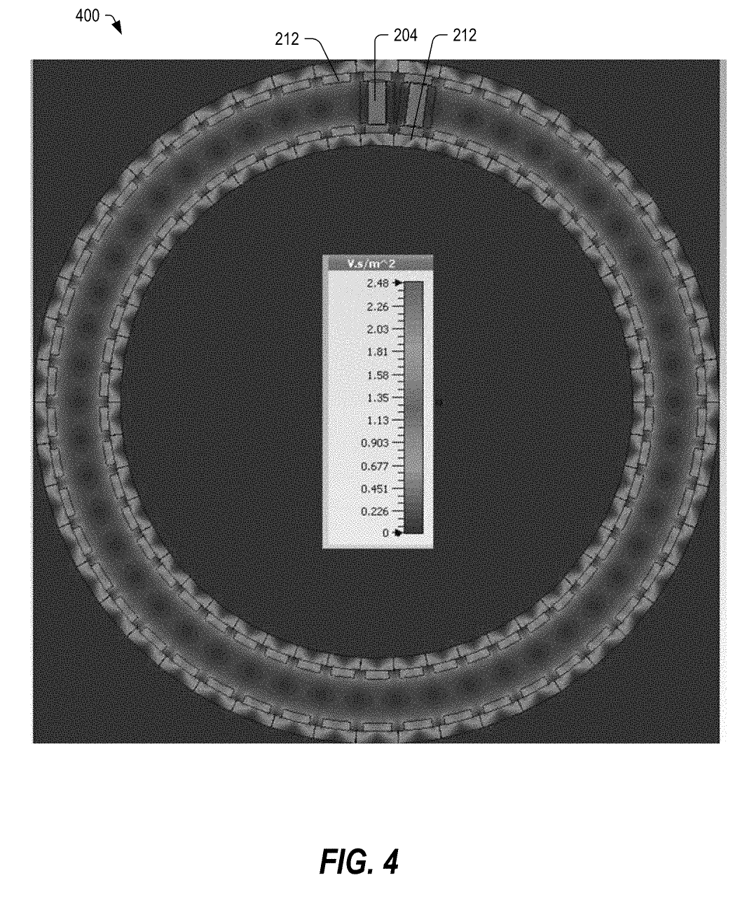

FIG. 4 depicts a graphical view 400 of magnetic fields produced by the motor (stator and rotor) of FIGS. 1-3 showing that the magnetic field lines are contained by the inner and outer magnetic arrays, in accordance with certain embodiments of the present disclosure. The view 400 includes the inner magnet array 210, the outer magnet array 214, and stator coils 204. In the illustrated example, the magnetic field is depicted as approximately zero both inside the periphery of the inner magnetic array 210 and outside the periphery of the outer magnetic array 212. The absence of field lines outside of the magnetic arrays 210 and 212 indicates that there is no loss of efficiency from the magnetic fields leaking outside of the arrays 210 and 212.

Further, it should be appreciated that the complete containment of the magnetic field lines within the arrays 210 and 212 provides a significant structural advantage over conventional magnetic arrays. In particular, since magnetic field lines typically leak out, shielding materials are typically used to prevent magnetic interference. Such materials are often heavy and expensive. Since the magnetic fields do not extend beyond the periphery of the arrays 210 and 212 in the embodiments disclosed herein, the external covers for the arrays 210 and 212 may be formed from relatively light-weight materials, such as plastics, composite materials, ceramics, other materials, and the like, without concern for magnetic interference with nearby circuits or structures.

Further, since the magnetic field lines are contained by the array, non-ferromagnetic structural elements may be used, which encourages the use of specialized structural materials and which can dramatically reduce the machine weight. Moreover, the containment of the fields may reduce non-working copper losses by a factor of two or more. Further, the containment of the fields may dramatically reduce volumetric frequency dependent losses, because the magnetic fields are isolated into the working volume gap.

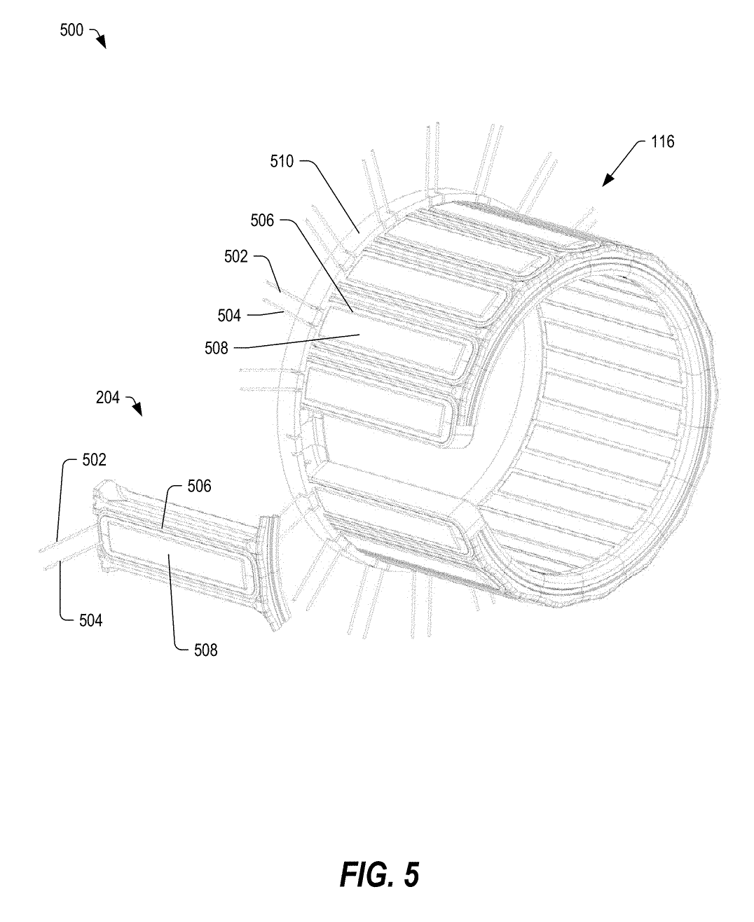

FIG. 5 depicts a perspective view 500 of the stator assembly 116 of the motor of FIGS. 1-4, in accordance with certain embodiments of the present disclosure. The stator assembly 116 may include a base 510 coupled to a plurality of stator coils 204. Each stator coil 204 may include a wire or coil 506 wrapped around a laminate core 508. The wire or coil 506 may include an input 502 and an output 504 coupled to a control circuit (such as the circuitry 112 in FIG. 1).

The stator assembly 116 may include a plurality of stator coils 204 arranged circumferentially about a center axis. The inner magnet array 210 and the outer magnetic array 212 of the rotor 118 may be configured to fit over the stator coils 204 to interact magnetically with the stator coils 204. Other embodiments are also possible.

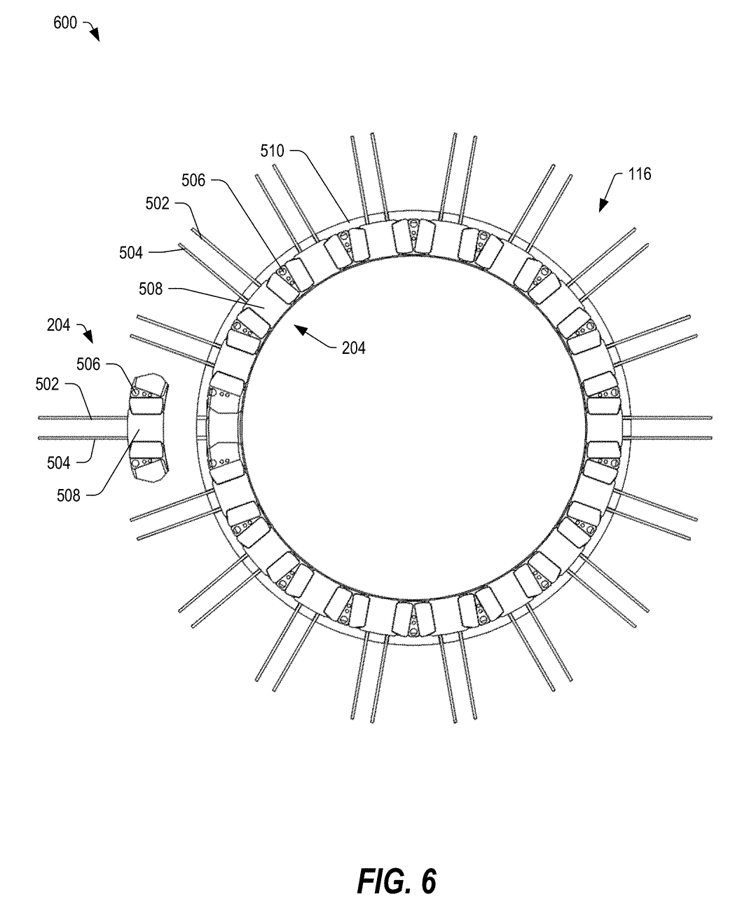

FIG. 6 depicts a top view 600 of the stator assembly 116 of FIGS. 1-5, in accordance with certain embodiments of the present disclosure. The stator assembly 116 includes a plurality of stator coils 204. Each stator coil 204 may include the input 502, the output 504, the coil 506, and the laminate core 508. The plurality of the stator coils 204 may be electrically and mechanically coupled to the base 510 to form the stator assembly.

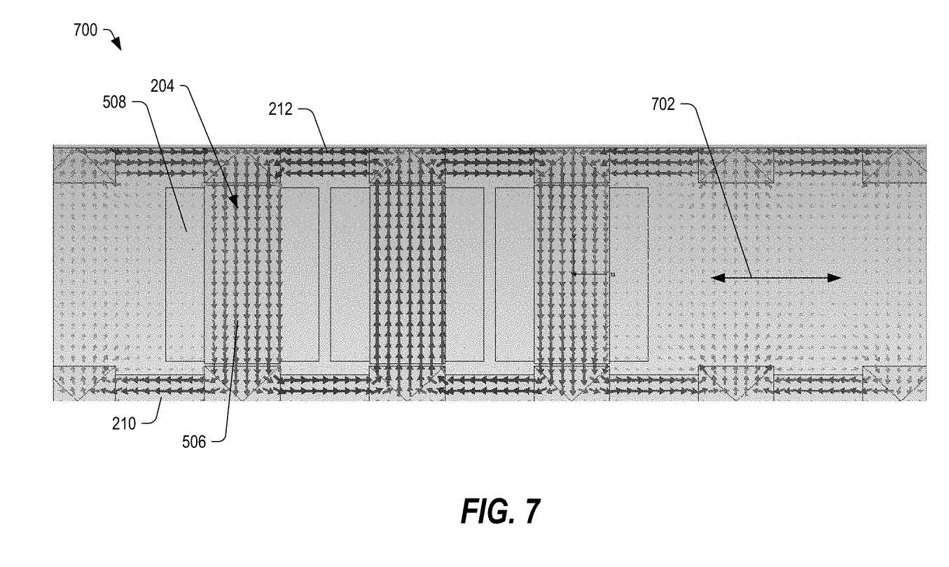

FIG. 7 depicts a top view 700 of a portion of the motor of FIGS. 1-6 depicting field lines extending between the inner magnet array 210 and the outer magnet array 212 through stator coils 204 positioned between the arrays 210 and 212, in accordance with certain embodiments of the present disclosure. The magnet arrays 210 and 212 may be formed from a plurality of small magnets coupled to one another and/or arranged to direct magnetic field lines through the coils 402 and through the arrays 210 and 212, reducing or eliminating magnetic field line leakage outside of the arrays 210 and 212, thereby enhancing overall efficiency. The current flowing in the coils 204 induces a magnetic field in the stator assembly 116, which interactions with the permanent magnets of the arrays 210 and 212 to cause the arrays 210 and 212 to move along a path indicated by arrow 702. Other embodiments are also possible.

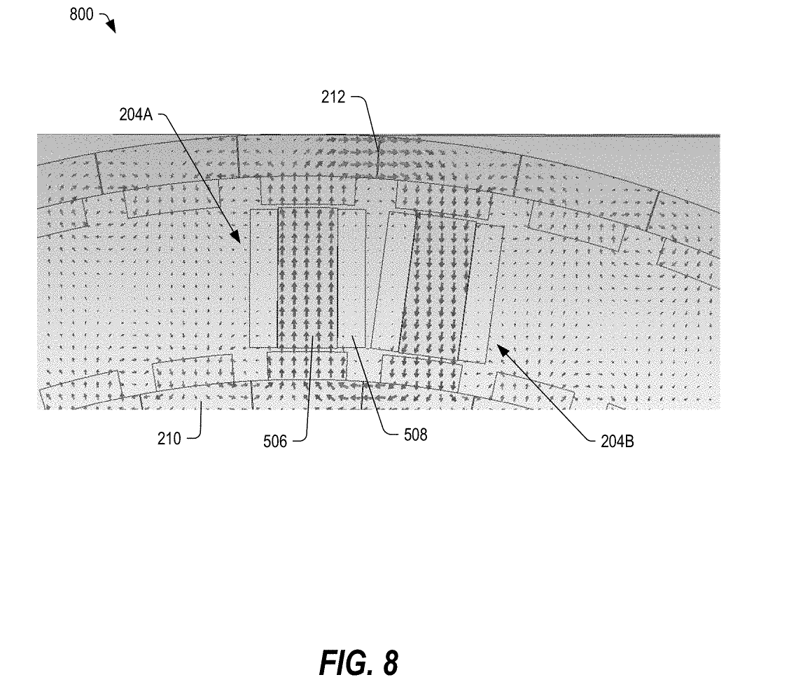

FIG. 8 depicts a top view of a portion 800 of the motor of FIGS. 1-7 depicting magnetic field lines and curvature of the arrays 210 and 212 and the stator assembly 116, in accordance with certain embodiments of the present disclosure. In the illustrated example, magnetic field lines form a closed circuit extending from the inner magnet array 210 through the coil 204A to the outer magnet array 212. The field lines flow through a portion of the outer magnet array 212 and return to the inner magnet array 210 through a second coil 204B. The magnetic field circuit applies torque to the inner magnet array 210 and the outer magnet array 212, causing the arrays 210 and 212 to turn.

It should be appreciated that the inner and outer magnet arrays 210 and 212 are formed from a plurality of magnets of the same size. The magnets may be coupled and/or arranged to direct the magnetic field lines, and the sides of the magnets may be coated to further facilitate the directing of the field lines, such that the magnetic arrays 210 and 212 experience little or no magnetic field line leakage outside of the arrays 210 and 212. This makes it possible to use lighter materials to encase the arrays 210 and 212 than would be possible in conventional arrays, in part, because conventional systems use heavy metallic materials in order to contain the magnetic fields, which is not a concern with the arrays 210 and 212.

Each independent magnetic circuit module may include an inner magnetic source and an outer magnetic source spaced apart by a distance defining a channel sized to receive a central magnetic source (e.g., the magnetic coil). The inner and outer magnetic sources may be permanent magnets, electromagnets, or any combination thereof. The magnetic poles of the inner magnetic source and the outer magnetic source may be offset by half of a pole pitch. The magnetic pole alignment of the central magnetic source may be parallel to a center line between the inner magnetic source and the outer magnetic source. In the circular arrangement of FIGS. 3-6, the pole alignment of the central magnetic source (e.g., the magnetic coil 204) may be parallel to a tangent line of each of the inner magnet array 210 and the outer magnet array 212 at a center point of the central magnetic source.

In some embodiments, the array of independent magnetic circuits allows for the use of non-magnetically conductive structural elements. Additionally, the independent magnetic circuit modules may reduce the need for mechanically derivative “phase windings” and can be arranged to achieve uniform circular motion about a central axis. In some embodiments, each of the magnetic coils 204 of the array of magnetic coils may be independently controlled to provide segmented, individual, independent actuation of the rotor. In the circular magnetic arrays, sets or “pole pairs” of inner and outer magnetic sources can be added to abate the magnetic alignment or magnetic “locking” of a rotating assembly.

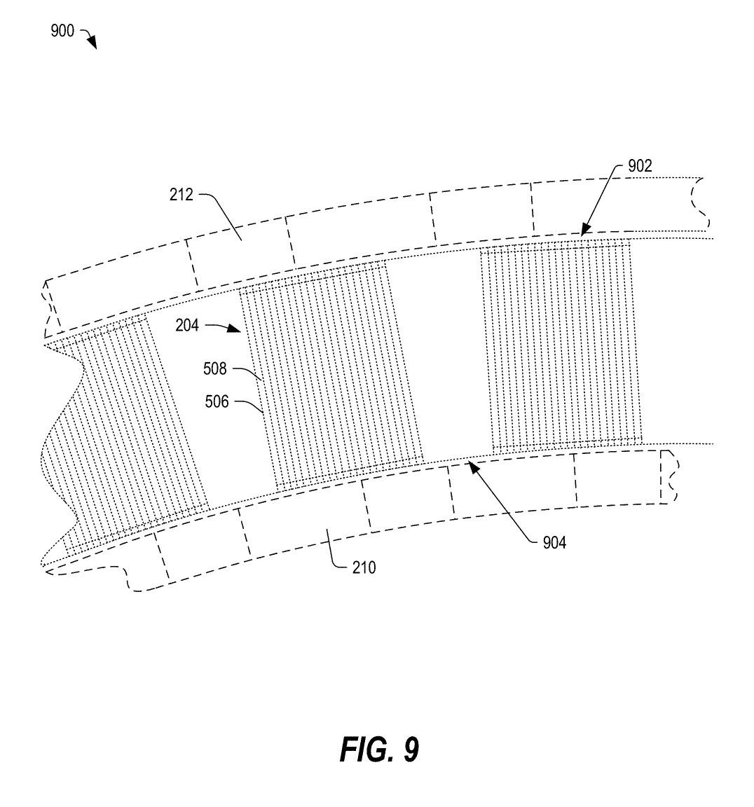

FIG. 9 depicts a portion 900 of the motor 104 of FIGS. 1-8 including portions of the inner and outer magnetic arrays 210 and 212 and the stator assembly 116, in accordance with certain embodiments of the present disclosure. The portion 900 depicts a close up view of individual magnetic circuit modules in the circular array. Each magnetic coil 204 (e.g., central magnetic source) may include a coil 506 wrapped around a laminate core 508. Each magnetic coil 204 may be individually and independently controlled to produce a desired magnetic torque, which may cause the rotor 118 to turn based on magnetic interaction between the field produced by the coil 204 and the magnetic fields produced by the inner and outer magnets 210 and 212.

The magnetic circuit modules formed by a pair of adjacent coils 204 and the magnets of the inner array 210 and the outer array 212 allow for the electromagnetic work to be done in the “gap” between the coils 204 and the arrays 210 and 212 (i.e., gaps 904 and 902).

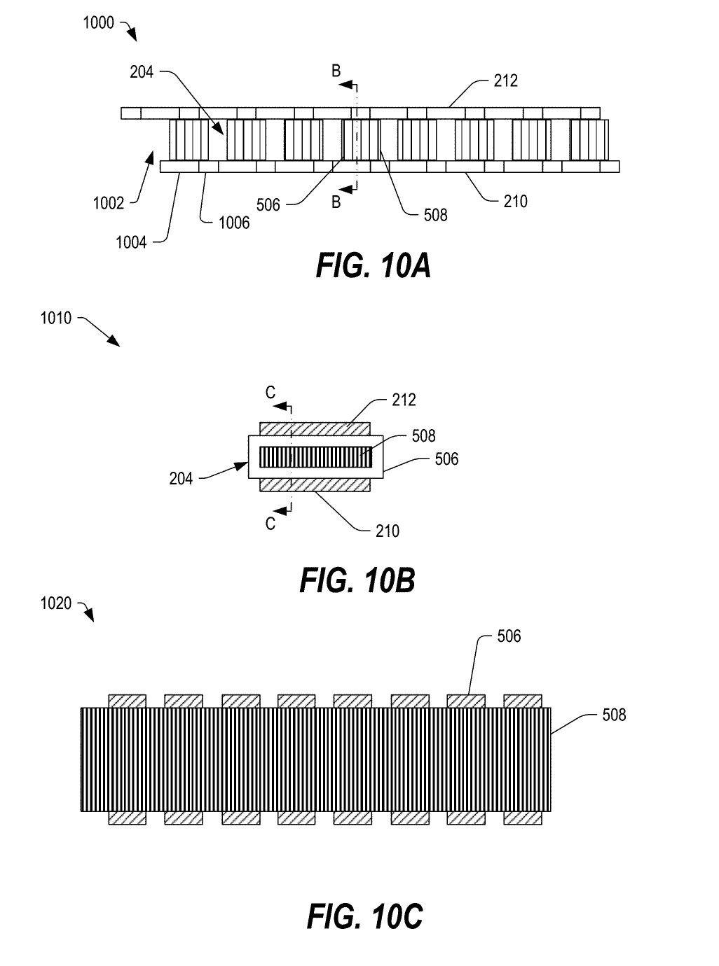

FIG. 10A depicts a portion 1000 of the motor 104 of FIGS. 1-10 rearranged as a Halbach array, in accordance with certain embodiments of the present disclosure. In this example, the inner magnetic array 210 may include a plurality of permanent magnets arranged to provide a spatially varying magnetic field. The outer magnetic array may also include a plurality of permanent magnets arranged to provide a spatially varying magnetic field. The magnetic poles of the magnets of the inner magnetic array 210 may be offset from the magnetic poles of the magnets of the outer magnetic array 212 by a selected percentage of the pole pitch. In a particular embodiment, the offset may be approximately half of the pole pitch.

The central magnet source may fit within the channel 1002 between the inner magnetic array 210 and the outer magnetic array 212. The central magnet source may be formed by a plurality of electromagnetic coils 204. Each electromagnetic coil 204 may include a plurality of coils of a conductive wire 506 wrapped around a laminate core 508.

In the illustrated example of FIG. 10A, the magnets of the inner array 210 and the magnets of the outer array 212 are depicted as being formed from different sized magnets, such as a magnet 1004 that is depicted as being larger than the adjacent magnet 1006. It should be understood that the relative sizes of the magnets are provided for illustrative purposes only. In implementation, the sizes may vary. In a particular embodiment, the arrays 210 and 212 may be formed from a plurality of magnets that are all the same size and that have the same magnetic properties. The magnets may be arranged in series and in particular orientations to direct and contain the magnetic fields. By utilizing this configuration, the magnetic fields can be easily contained by the magnetic arrays 210 and 212 with little or no magnetic field leakage outside of the periphery of the magnetic arrays 210 and 212. Thus, the configuration of magnets of the arrays 210 and 212 may provide improved efficiency relative to an array with variable size and/or larger magnets. In an embodiment, the larger magnets may be formed by a plurality of small magnets coupled in series.

FIG. 10B depicts a cross-sectional view 1010 of the Halbach array taken along line B-B in FIG. 10A. In the view 1010, a magnetic module is shown that includes the magnetic coil 204 including the coil 506 and the laminate core 508 and including inner magnets and outer magnets of the inner array 210 and the outer array 212, respectively.

FIG. 10C depicts a cross-sectional view 1020 of a magnetic coil assembly taken along line C-C in FIG. 10B. The view 1020 includes the laminate core 508 and wires of the coil 506.

In some embodiments, current flowing through the wire of the coils induces a magnetic field having poles that extend out of ends of the laminate core 508. The ends are the sides of the laminate core 508 in FIG. 10C that are not contacted by the coil 506.

In operation, the magnetic field of the magnetic coil 204 extends out of the ends of the magnetic coil 204 and couple to the magnets of the inner magnetic array 210 and the outer magnetic array 212, applying a magnetic force to the magnets of the arrays 210 and 212 to move the rotor.

In some embodiments, by driving the magnetic coils, the laminate core may be driven into partial saturation. The magnetic coil assemblies 204 assist in closing a magnetic circuit between the inner and outer magnet arrays 210 and 212. By controlling current flow through the magnetic coil assemblies 204, the magnetic coil assemblies 204 may cooperate to apply torque to the inner and outer magnet arrays 210 and 212 to move the rotor 118 relative to the stator assembly 116. Other embodiments are also possible.

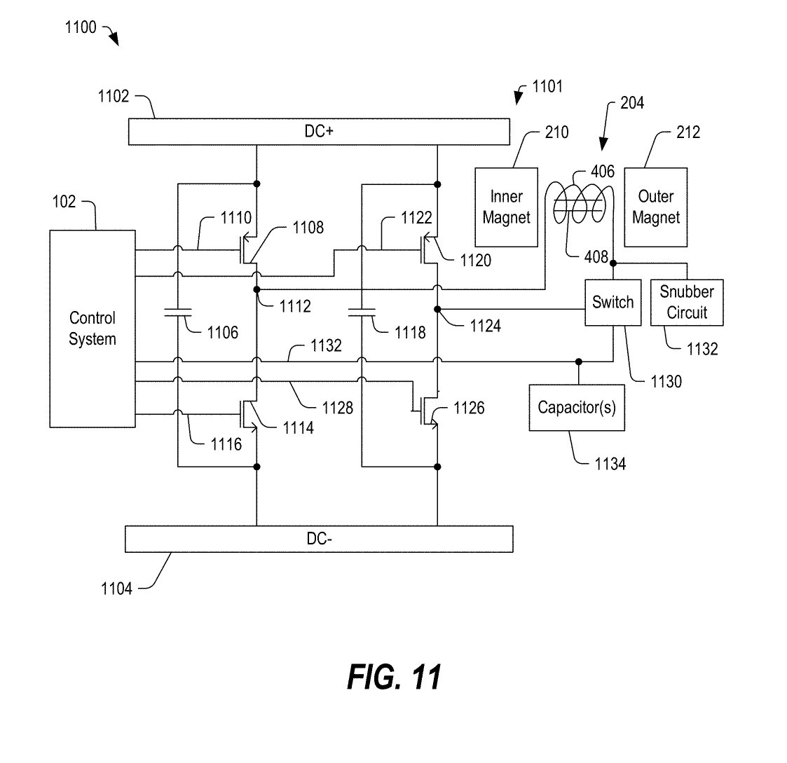

FIG. 11 depicts a system 1100 including a circuit 1101 configured to drive a magnetic coil assembly, in accordance with certain embodiments of the present disclosure. The circuit 1101 may be an embodiment of at least a portion of the circuit 112 in FIG. 1. The circuit 1101 may include a control system 102, such as the control system 102 described with respect to FIG. 1. The circuit 1101 may further include a first power bus 1102 and a second power bus 1104. The circuit 1101 may further include a capacitor 1106 and a capacitor 1118, each of which may be coupled between the first power bus 1102 and the second power bus 1104. The circuit 1101 may also include an H-Bridge configuration including transistors 1108, 1114, 1120, and 1126. The transistor 1108 may include a source coupled to the first power bus 1102, a gate coupled to the control system 102 by a node 1110, and a drain coupled to a node 1112. The node 1112 may be coupled to a first end of a winding 506 around a core 508 of the plurality of electromagnetic coil assemblies 204. The transistor 1114 may include a drain coupled to the node 1112, a gate coupled to the control system 102 by a node 1116, and a source coupled to the second power bus 1104. The transistor 1120 may include a source coupled to the first power bus 1102, a gate coupled to the control system 102 by a node 1122, and a drain coupled to a node 1124. The transistor 1126 may include a drain coupled to the node 1124, a gate coupled to the control system 102 by a node 1128, and a source coupled to the second power bus 1104.

The circuit 1101 may include a switch 1130, which may be an insulated gate bipolar transistor, an insulated gate field effect transistor, or another insulated switch capable of switching high current, high voltage, or both. The switch 1128 may include a first input coupled to a second end of the coil 406 of the electromagnetic coil 204. The switch 1128 may include a second input coupled to the node 1124, and a third input coupled to the control system by a node 1132.

It should be appreciated that the H-bridge, capacitors 1106, and 1118, and the switch 1130 may be replicated for each electromagnetic coil assembly 204 so that the power switching component 1130 may be controlled by the control system 102 to independently control the electromagnetic portion of each of the magnetic modules. Each electromagnetic coil may have an associated circuit.

In the illustrated example, the control system 102 may selectively bias the transistors 1108, 1114, 1120, and 1126 to turn on and off to drive current through the coil 506. The control system 102 may selectively activate the transistors 1108, 1114, 1120, and 1126 for each coil 506 of an array of electromagnetic coil assemblies to provide independently controllable magnetic sources.

In some embodiments, the circuit 1101 may include a snubber circuit 1132 coupled to the coil 506. The snubber circuit 1132 may provide energy-absorbing functionality to suppress voltage spikes caused by inductance of the coil 506 when the switch 1130 transitions. The snubber circuit 1132 may include a capacitor for energy storage coupled to the switch 1130. In some embodiments, one or more additional capacitors 1134 (which may or may not be part of the snubber circuit 1132) may be coupled to the switch 1130 to store energy from the coil 506 during transitions, allowing for energy capture and reuse with reduced loss, as compared to a system that would transfer the coil's energy back to a power source. It should be appreciated that the snubber circuit 1132 may be an embodiment of the snubber circuits 144 of the circuitry 112 in FIG. 1. Further, the capacitors 1134 and the capacitor 1106 may be embodiments of the capacitors 146 of the circuitry 112 in FIG. 1. Other embodiments are also possible.

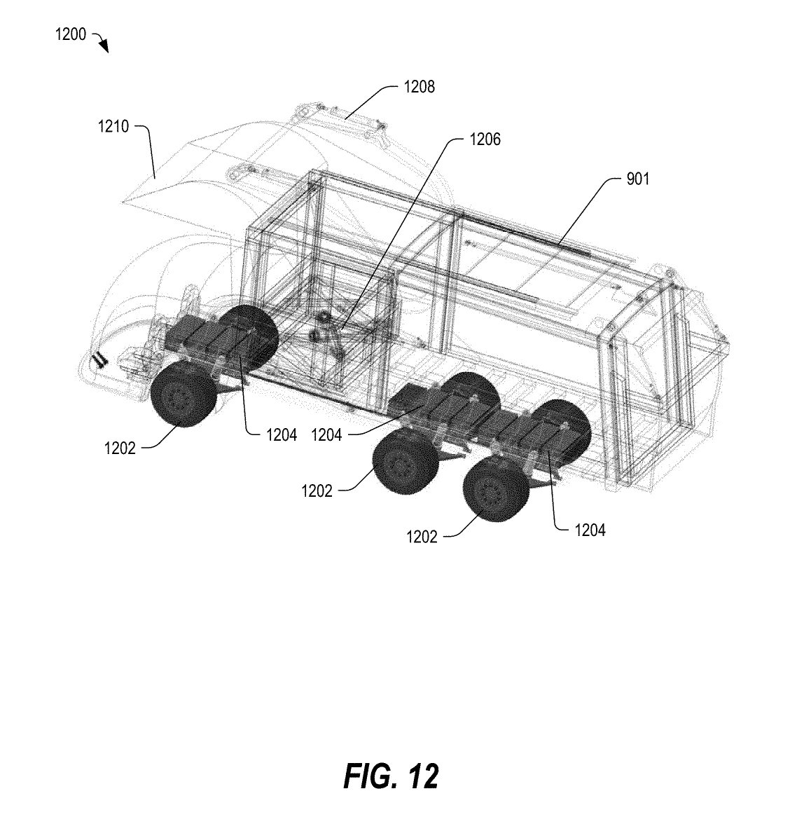

FIG. 12 depicts a system 1200 including an electric powered vehicle 1201, which may include one or more electrical motors, in accordance with certain embodiments of the present disclosure. The vehicle 1201 may include a plurality of wheel modules 1202, each of which may include a motor 104 as described above with respect to FIGS. 1-11 and 11. The motor 104 may be part of the hub of the wheel module 1202, such that the turning of the rotor 118 causes the tire of the wheel module 1202 to turn. Further, a plurality of batteries 1204 may be coupled to each wheel module 1202 and may be coupled to or may form part of the frame of the vehicle 1201.

In the illustrated embodiment, the vehicle 1201 may include actuatable elements 1206, which may be configured to move to control a tilt of a rear portion of the vehicle 1201. In some embodiments, the actuatable elements 1206 may be activated to raise the hopper portion of the vehicle 1201, for example, to dump the contents. The vehicle 1201 may also include actuatable elements 1208 coupled to a lift mechanism 1210, which may lift a garbage can or dumpster and raise it over the hopper to empty the contents into the hopper. It should be appreciated that the motive force behind each of the actuators of the vehicle 1201 may be implemented as electric motors as shown and described above with respect to FIGS. 1-11 and 11.

In conjunction with the motors, systems and methods described above with respect to FIGS. 1-12, a motor is disclosed that may include a rotor including an inner magnetic array, an outer magnetic array, and a channel disposed between the inner and outer magnetic arrays. The motor may further include a stator assembly including a plurality of electromagnets configured to fit within the channel. The stator assembly may be fixed to a housing and to a structure, such as the frame of a vehicle, and the rotor may be configured to move relative to the stator assembly.

In a particular embodiment, the motor may include a stator assembly and a rotor assembly. The rotor assembly may include a first magnetic array and a second magnetic array that separated by a channel having a depth that extends in a direction that is substantially parallel to an axis of rotation of the rotor assembly. The stator assembly may include a plurality of electromagnets configured to fit within the channel and adapted to generate a time-varying magnetic field to apply a motive force to the rotor assembly. In some embodiments, a control circuit may selectively apply current to the electromagnets independently and at selected phases. In a particular example, the control circuit may drive the electromagnets with any number of different phases.

The motor and its components, described above with respect to FIGS. 1-12, may be configured to enhance performance (torque at desired rpm) within limits of machine health management on a continuous or burst mode basis, within each coil and power electronics unit. Normally efficiency can be maximized to minimize losses and heat generated at the desired power level, which can be achieved through switch-on/off and pulse-width-modulation (PWM) optimization, incorporating feedback from machine health management sensors and computations. In some embodiments, the circuitry 112 may be configured to provide graceful/soft failure mitigation, such as by controlling individual control electronics for each coil, reducing stress on coil insulation or power electronics prior to coil short or other failure. Electromagnetic fields (EMF) following in each coil and power electronics unit may reduce any contribution to torque ripple, acoustic noise or negative impact on torque at any rpm.

In some embodiments, the motor control may be implemented to operate in a dual-quadrant configuration, but the magnetic circuits may be segmented into any number of sectors, depending on the power electronics groupling/implementation. The modularity and versatility allows for a wide range of DC link voltages while ensuring that each quadrant uses similar power, which may also extends machine life and provides significant flexibility and redundancy for fault tolerance.

In some embodiments, the radial circumferential power array and the associated power electronics design can utilize series/parallel power switching architectures incorporating gate drives with sensing, gradual switching and other measures to identify and manage fault conditions. Networked deterministic microcontrollers may be included to perform real-time transforms as gate control signals optimize switching to manage electromagnetic cycle energy. Rapid graduated shutdown features may be implemented to minimize fault currents in less than 1 microsecond (typically ˜100 nanoseconds).

In some embodiments, controller and communication functions allow multiple feedback loops and DC link supply control management. These functions allow for power electronics communication and coordination prior to increasing demand in electrical machine, maximizing system response and power distribution system stability.

Embodiments of the motors and components and systems described above with respect to FIGS. 1-12 may provide significant advantages in performance, efficiency, weight, and design scalability over conventional motors. The advantages can be realized for different sizes and torque motors and generators, from approximately 1 megawatt to motors/generators in the 5 to 10 megawatt range. Further, the motor may be scaled to operate with 1800 to 3600 RPM generators that operate in the 8-12 megawatt range. All of these implementations can have a high power and very high power density operation, which can work well with the DC power distribution and nearby power electronics disclosed herein.

Although the present invention has been described with reference to preferred embodiments, workers skilled in the art will recognize that changes may be made in form and detail without departing from the scope of the invention.

What is claimed is:

1. A motor comprising:
a rotor assembly including a plurality of magnets and configured to rotate about an axis, the plurality of magnets arranged in two arrays including an inner array and an outer array spaced apart by a channel, the channel extending circumferentially about the axis;
a stator assembly including a plurality of electromagnets configured to fit within the channel; and
a control circuit coupled to the stator assembly and configured to control current flow to each of the plurality of electromagnets, independently, to dynamically adjust a magnetic phase of each of the plurality of electromagnets.

2. The motor of claim 1, further including a housing coupled to the stator assembly and configured to define an enclosure sized to secure the rotor assembly, the stator assembly, and the control circuit.

3. The motor of claim 2, wherein the housing is formed from a non-ferromagnetic material.

4. The motor of claim 2, wherein the housing is formed from a composite material.

5. The motor of claim 1, wherein the plurality of magnets comprises at least one of permanent magnets and electromagnets.

6. The motor of claim 1, wherein:
the inner array defines a first magnetic pole;
the outer array defines a second magnetic pole; and
the first magnetic pole is offset from the second magnetic pole by approximately half of a pole pitch.

7. The motor of claim 1, wherein each of the plurality of electromagnets of the stator assembly has a magnetic pole that is substantially parallel to a center of the channel.

8. The motor of claim 1, further comprising control electronics associated with each of the plurality of electromagnets of the stator assembly, the control electronics associated with each electromagnet including:
at least one of a snubber circuit and a capacitor configured to store energy from switching of the electromagnets; and
switching circuity to selectively control current flow to and from the electromagnet and to the at least one of the snubber circuit and the capacitor.

9. A motor comprising:
a rotor assembly including an inner array of magnets and an outer array of magnets spaced apart by a channel and configured to rotate about an axis;
a stator assembly including a plurality of electromagnetic coils configured to fit within the channel; and
a control circuit configured to drive the plurality of electromagnetic coils asynchronously to form an array of independent magnetic circuits configured to turn the rotor assembly relative to the stator assembly.

10. The motor of claim 9, wherein at least a portion of the rotor assembly is formed from a non-magnetically conductive structural material.

11. The motor of claim 9, wherein the inner array of magnets, the outer array of magnets, and the plurality of electromagnetic coils are arranged to achieve uniform circular motion.

12. The motor of claim 9, wherein each of the plurality of electromagnetic coils is individually controllable to allow for segmented individual actuation.

13. The motor of claim 9, further comprising control electronics associated with each of the plurality of electromagnet coils of the stator assembly, the control electronics associated with each electromagnet coil including:
at least one of a snubber circuit and a capacitor configured to store energy from switching of the electromagnet coil; and
switching circuity to selectively control current flow to and from the electromagnet coil and to the at least one of the snubber circuit and the capacitor.

14. The motor of claim 9, wherein:
the inner array of magnets defines a first magnetic pole;
the outer array of magnets defines a second magnetic pole; and
the first magnetic pole is offset from the second magnetic pole by approximately half of a pole pitch.

15. A motor comprising:
a stator assembly including a plurality of coils arranged circumferentially about an axis;
a rotor assembly including an inner array of magnets arranged circumferentially about the axis and an outer array of magnets arranged around and spaced apart from the inner array of magnets to form a channel sized to receive the plurality of coils of the stator assembly; and
circuitry including a plurality of power electronics circuits, each power electronic circuit associated with a coil of the plurality of coils and configured to control switching of current into and out of the coil independently from each of the other coils of the plurality of coils.

16. The motor of claim 15, further comprising a housing configured to enclose the stator assembly, the rotor assembly, and the circuitry, the housing formed from a non-magnetically conductive structural material.

17. The motor of claim 15, wherein each of the plurality of coils is individually controllable to allow for segmented individual actuation.

18. The motor of claim 17, wherein the each coil is controlled independently of others of the plurality of coils to provide a polyphase operation.

19. The motor of claim 15, wherein each power electronics circuit comprises:
at least one of a snubber circuit and a capacitor configured to store energy from switching of the coil; and
switching circuity to selectively control current flow to and from the coil and to the at least one of the snubber circuit and the capacitor.

20. The motor of claim 15, wherein:
the inner array of magnets defines a first magnetic pole;
the outer array of magnets defines a second magnetic pole; and
the first magnetic pole is offset from the second magnetic pole by approximately half of a pole pitch.
